(19) United States
(12) Patent Application Publication
(10) Pub. No.: US 2017/0095880 A1
(43) Pub. Date: Apr. 6, 2017

(54) SWING ARM ASSEMBLY FOR INTERACTING WITH A SPOT WELDING TIP

(71) Applicant: G.E. Schmidt, Inc., Blue Ash, OH (US)

(72) Inventors: Drew Sherlock Johnson, Montgomery, OH (US); Andrew Ryan Johnson, Cincinnati, OH (US); Jonathan Michael Dutton, Cincinnati, OH (US); Steven Mathew Daviaux, Somerville, OH (US); Dilshan Thilina Modaragamage, Barrie (CA)

(21) Appl. No.: 15/286,007

(22) Filed: Oct. 5, 2016

Related U.S. Application Data
(60) Provisional application No. 62/353,912, filed on Jun. 23, 2016.
(60) Provisional application No. 62/237,791, filed on Oct. 6, 2015.

(51) Int. Cl. B23K 11/30; B23K 11/11

(52) U.S. Cl. CPC B23K 11/3063; B23K 11/11; B23K 11/3072

(57) ABSTRACT

A head for a swing arm assembly is provided for a spot welding machine. The head can accommodate a tip dresser or a tip exchanger.

### REFERENCE TO RELATED APPLICATIONS

This application claims priority to U.S. Provisional Patent Application Ser. Nos. 62/237,791, filed Oct. 6, 2015 and 62/353,912, filed Jun. 23, 2016, the contents each of which is incorporated herein by reference.

### BACKGROUND

In spot welding, the electrode tips can get worn and dirty and are thus cleaned periodically to maintain good quality welds. When the weld gun is carried by a robot, the robot can bring the gun to the tip dresser for cleaning. However, some weld guns are fix mounted and thus utilize a swing arm that brings the tip dresser to the electrode tips for cleaning.

### SUMMARY

In accordance with one embodiment, a swing arm for one or more of a tip dresser and a tip exchanger for a spot welding machine is provided. The swing arm comprises a base, an arm, and a head. The arm is pivotally coupled with the base. The head is coupled with the arm and is configured to accommodate one or more of a tip dresser and a tip exchanger for a spot welding machine. The head comprises a support member and a mount plate. The support member is attached to the arm. The mount plate is rotatably and slidably coupled with the support member such that the mount plate is rotatable and slidable about a first axis.

In accordance with another embodiment, a welding system comprises a spot welding machine, a swing arm, and one or more of a tip dresser and a tip exchanger. The swing arm comprises a base, an arm, and a head. The arm is pivotally coupled with the base. The head is coupled with the arm and comprises a support member and a mount plate. The support member is attached to the arm. The mount plate is rotatably and slidably coupled with the support member such that the mount plate is rotatable and slidable about a first axis. The one or more of a tip dresser and a tip exchanger is coupled with the mount plate.

In accordance with another embodiment, a head for a swing arm for one or more of a tip dresser and a tip exchanger for a spot welding machine is provided. The head is configured to accommodate one or more of a tip dresser and a tip exchanger for a spot welding machine. The head comprises a support member and a mount plate. The support member is attached to the arm. The mount plate is rotatably and slidably coupled with the support member such that the mount plate is rotatable and slidable about a first axis.

### BRIEF DESCRIPTION OF THE DRAWINGS

Various embodiments will become better understood with regard to the following description, appended claims and accompanying drawings wherein:

FIG. 1 is a perspective view of a swing arm assembly according to one embodiment, and having a tip dresser coupled to the swing arm assembly;

FIGS. 2-5 are various views depicting a head of the swing arm assembly;

FIG. 6 is a perspective view depicting a swing arm assembly according to another embodiment;

FIG. 7 is a perspective view depicting a swing arm assembly according to yet another embodiment;

FIG. 8 is a perspective view depicting a swing arm assembly according to yet another embodiment;

FIG. 9 is a perspective view depicting a swing arm assembly according to yet another embodiment;

FIG. 10 is a perspective view depicting an alternative embodiment of a head of a swing arm;

FIG. 11 is a perspective view depicting another alternative embodiment of a head of a swing arm;

FIG. 12 is a perspective view depicting yet another alternative embodiment of a head of a swing arm;

FIGS. 13-15 are various views depicting yet another alternative embodiment of a swing arm assembly;

FIGS. 16-19 are various views depicting yet another alternative embodiment of a swing arm assembly;

FIGS. 20-21 are various views depicting yet another alternative embodiment of a swing arm assembly; and

FIGS. 22-23 are various views depicting yet another alternative embodiment of a swing arm assembly.

### DETAILED DESCRIPTION

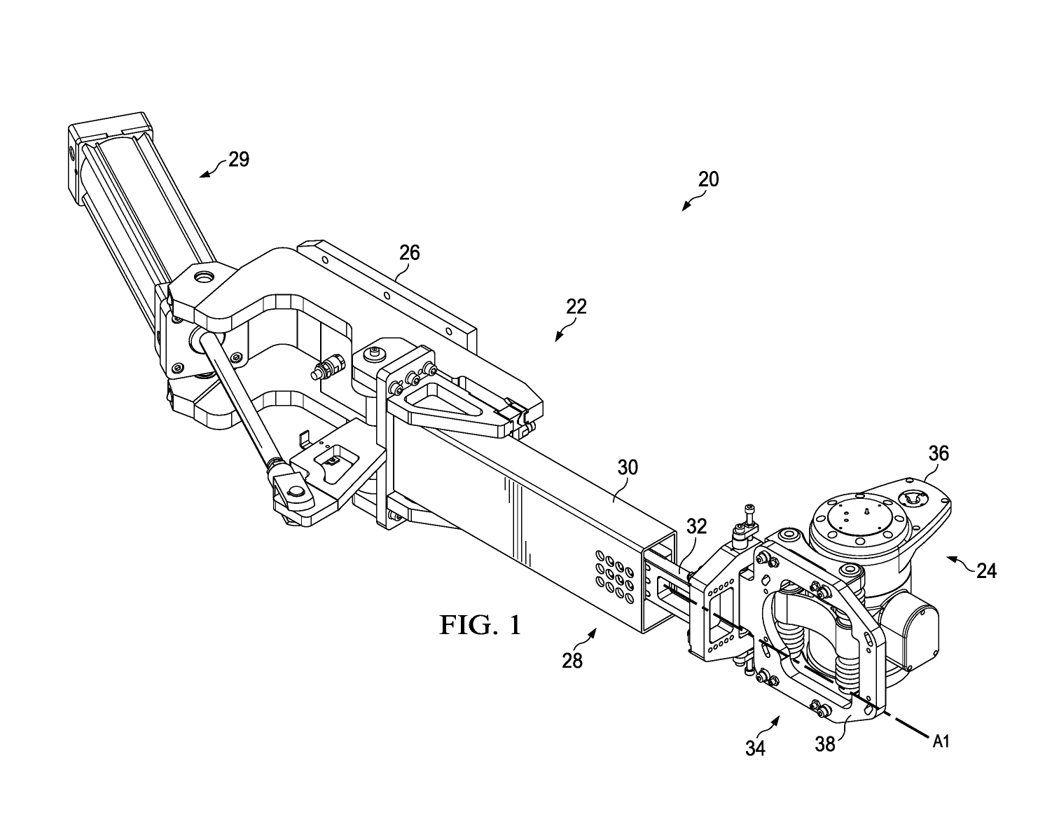

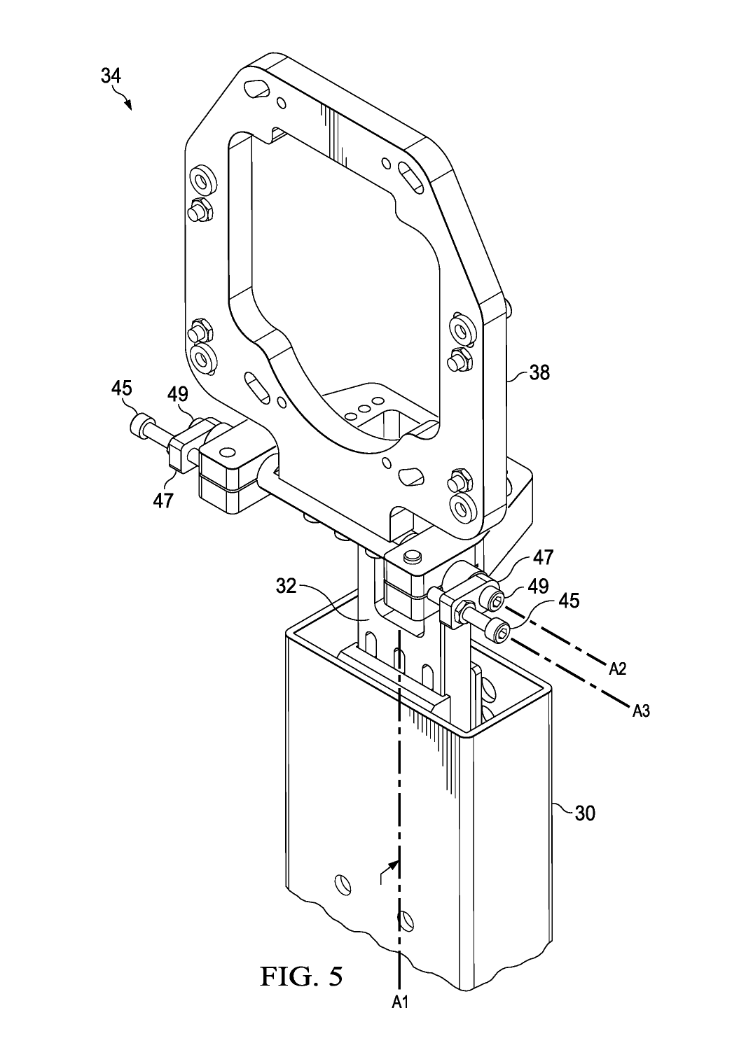

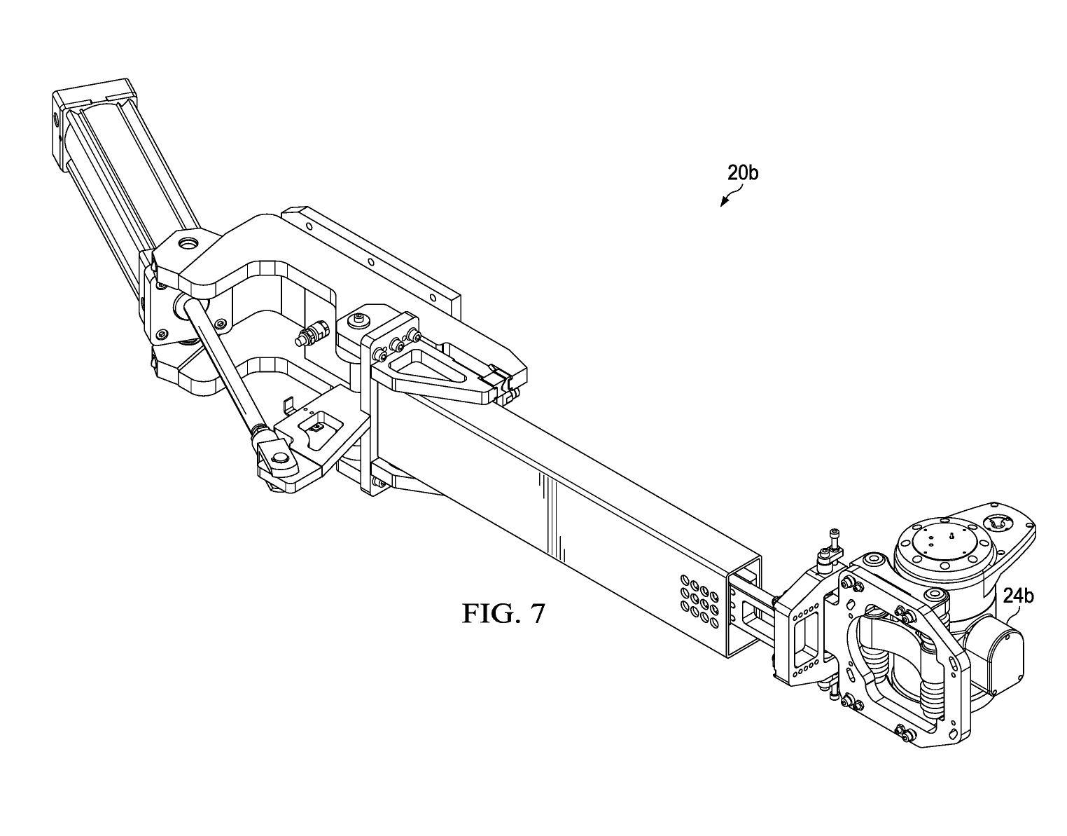

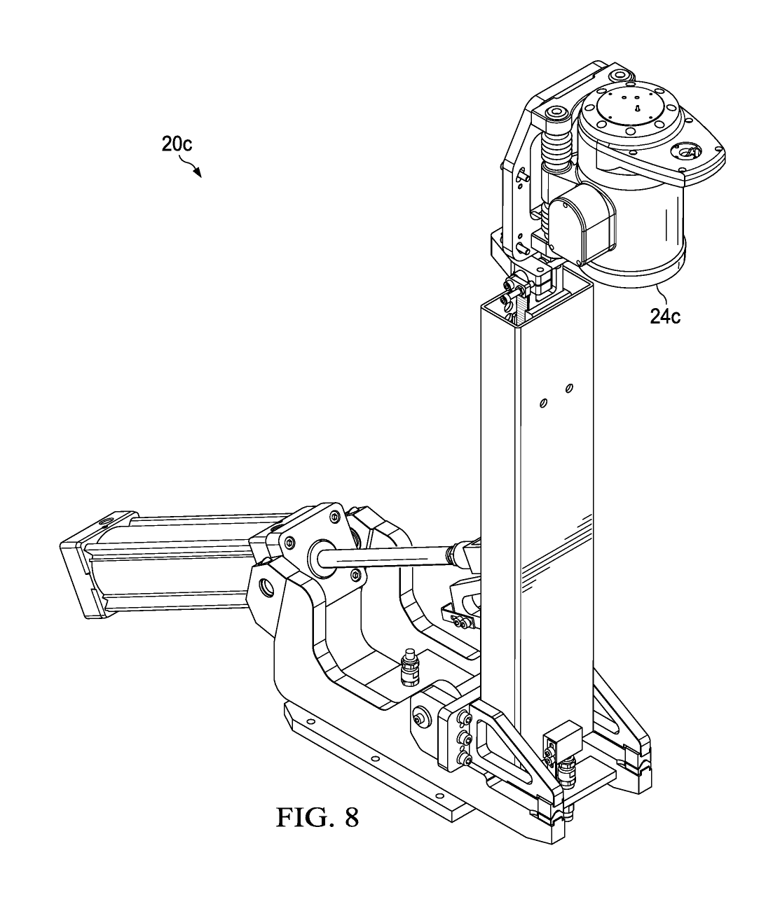

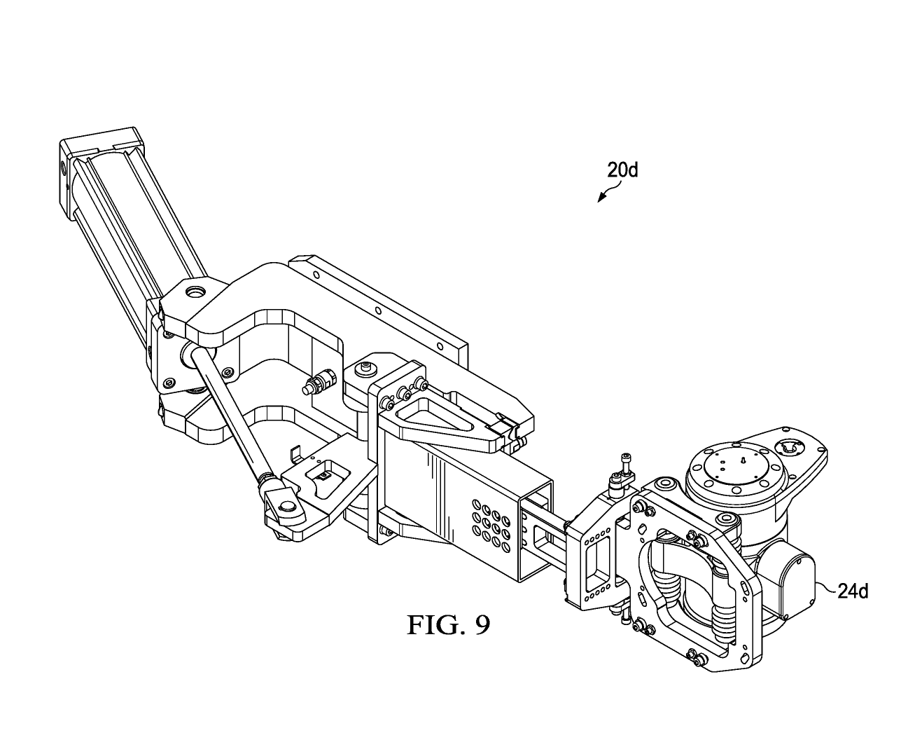

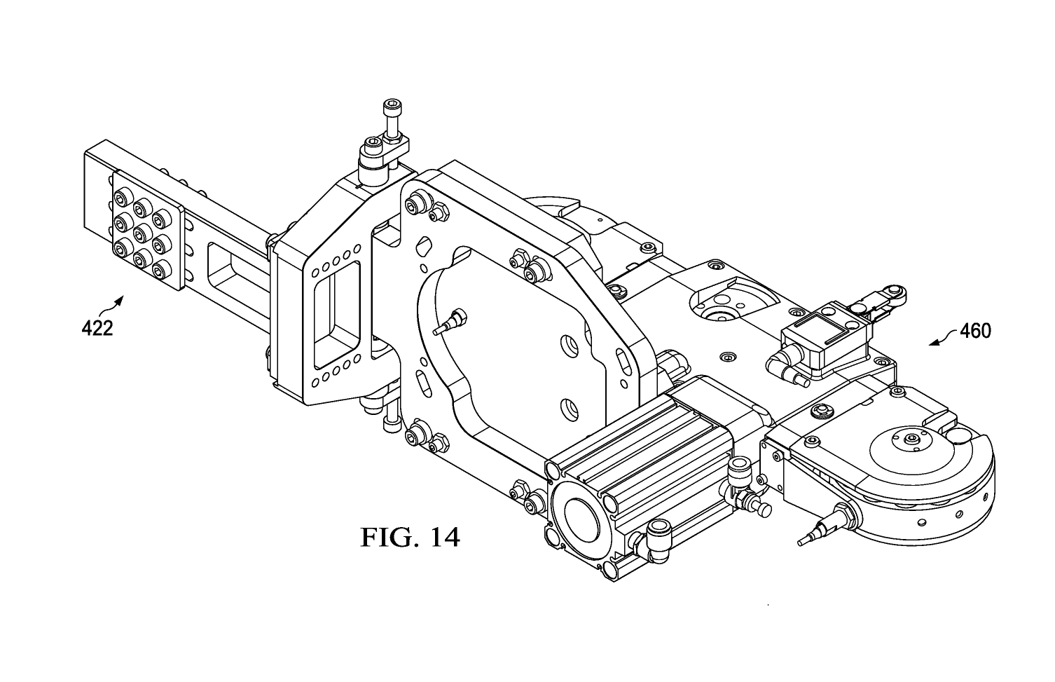

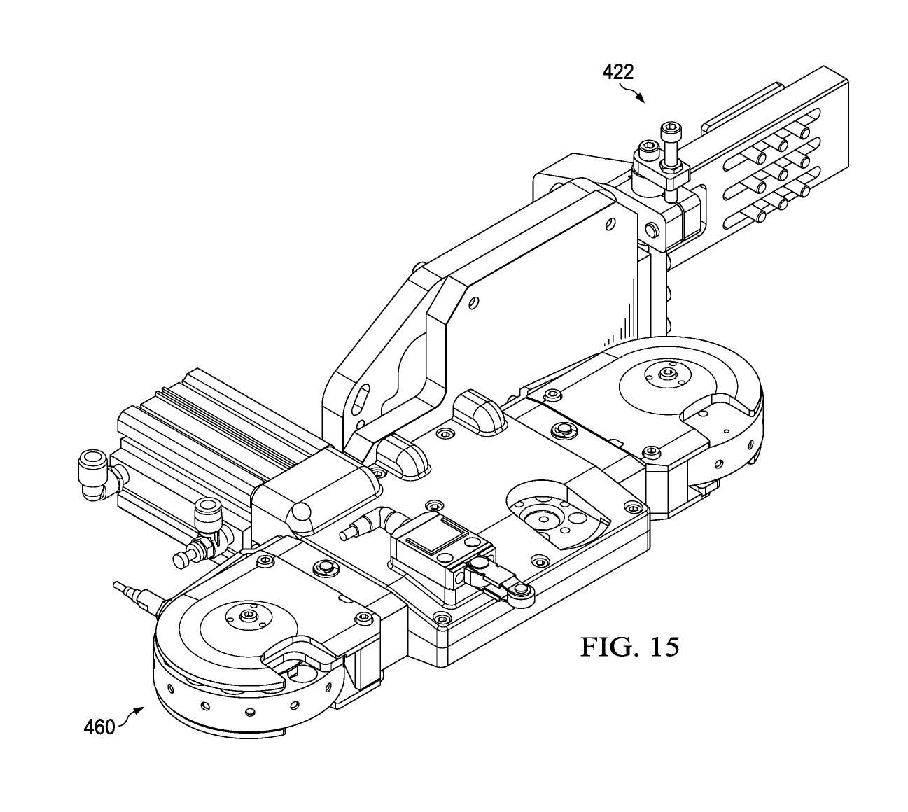

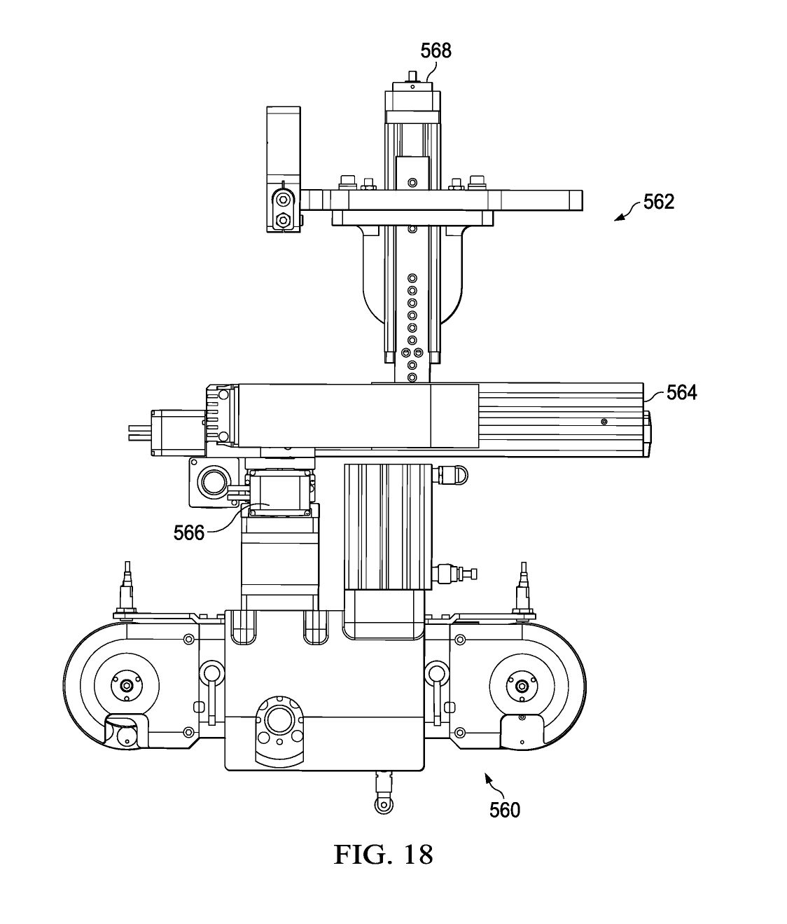

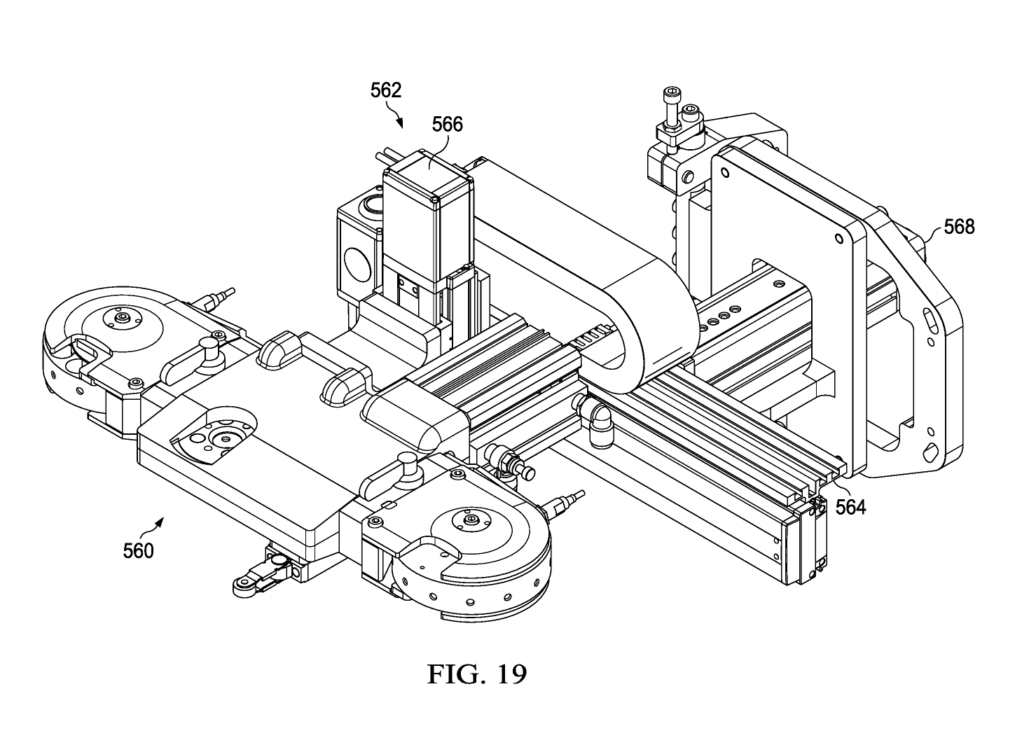

Embodiments are hereinafter described in detail in connection with the views and examples of FIGS. 1-23, wherein like numbers indicate the same or corresponding elements throughout the views. As illustrated in FIG. 1, a swing arm assembly 20 is provided that can include a swing arm 22 and a tip dresser 24. The swing arm 22 can selectively position the tip dresser 24 with respect to a welding tips of a spot welder (not shown) to facilitate cleaning/dressing of the welding tips. The swing arm 22 can include a mounting base 26, an arm assembly 28 pivotally coupled to the mounting base 26, and a driver cylinder 29 pivotally coupled to the mounting base 26. The driver cylinder 29 can operably mounted to the arm assembly 28 to facilitate in powered pivoting of the arm assembly 28 with respect to the mounting base 26. In one embodiment, the driver cylinder 29 can be a pneumatic drive. In other embodiments, any of a variety of drives can be used to facilitate powered pivoting of the arm assembly 28, such as, for example, a servo. The arm assembly 28 can include an arm 30, an extendible arm mount 32, and a head 34. The extendible arm mount 32 can be slidably coupled with the arm 30 and slidable along an axis A1 (FIG. 5) between a retracted position and an extended position. The head 34 can be mounted to the extendable arm mount 32 and can be configured to accommodate the tip dresser 24.

The mounting base 26 can facilitate mounting of the swing arm assembly 20 to a welding machine with fasteners (e.g., with bolts), to a floor, or at any of a variety of other suitable locations that allow the tip dresser 24 to interact properly with the spot welding machine (not shown). For example, when the spot welding machine is operating, the swing arm 22 can be in a stand-by position, such that the tip dresser 24 remains out of the operational zone of the spot welding machine. Once the welding tips are ready for dressing, the spot welding machine can cease spot welding, and the swing arm 22 can pivot the tip dresser 24 into position (via operation of the driver cylinder 29 and/or sliding of the extendible arm mount 32). The spot welding machine can then bring the welding tips into contact with a cleaning mechanism 36 on the tip dresser 24 to facilitate dressing of the welding tips. In one embodiment, the swing arm 22 can move the tip dresser 24 into place without requiring substantial movement of the spot welder. In another embodiment, the swing arm 22 and the spot welding machine can move together such that they meet at a predetermined location.

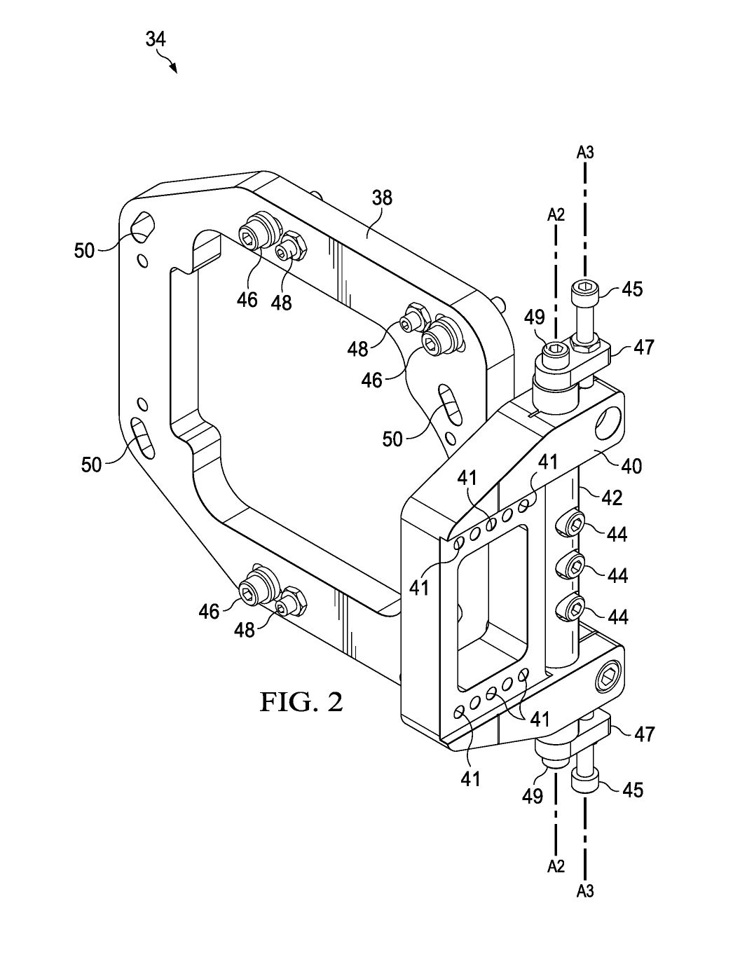

Referring now to FIGS. 2-5, the head 34 can include a mount plate 38 that is rotatably coupled with a support member 40 by a rotational adjustment tube 42 such that the mount plate 38 is rotatably about an axis A2. The support member 40 can include a plurality of mount holes 41 that allow for mounting of the support member 40 to the arm mount 32 in different positions. For example, the position of the support member 40 can be laterally adjusted by selecting different mount holes 41 by which to attach the support member 40 to the arm mount 32. The mount plate 38 can be releasably coupled to the rotational adjustment tube 42 by a plurality of fasteners 44. A pair of vertical adjustment bolts 45 can be associated with the support member 40 and can facilitate vertical positioning of the mount plate 38 with respect to the support member 40. Each of the vertical adjustment bolts 45 can be threaded through an extension plate 47 and into contact with the support member 40 on opposite sides of the support member 40. The vertical adjustment bolts 45 can be rotated in opposite directions (e.g., about an axis A3) to facilitate sliding of the rotational adjustment tube 42 along the axis A2. For example, one of the vertical adjustment bolts 45 can be rotated clockwise (e.g., to thread the vertical adjustment bolt 45 towards the support member) and the other vertical adjustment bolt 45 can be rotated counterclockwise (e.g., to thread the vertical adjustment bolt 45 away from the support member) to facilitate sliding of the rotational adjustment tube 42 along the axis A2.

The rotational adjustment tube 42 and the extension plates 47 can be releasably secured together by respective bolts 49 such that the rotational adjustment tube 42 is disposed between the extension plates 47. The bolts 49 can facilitate releasable securement of the rotational adjustment tube 42 in place. For example, the bolts 49 can be loosened to allow the rotational adjustment tube 42 to be pivoted about the axis A2. Once the rotational adjustment tube 42 is pivoted into a desired position, the bolts 49 can be tightened to hold the rotational adjustment tube 42 in place. In one embodiment, as illustrated in FIG. 2, the vertical adjustment bolts 45 can be offset from the axis A2 and arranged such that the axes A2 and A3 are substantially parallel but not coaxial (e.g., each vertical adjustment bolt 45 is spaced from the adjacent bolt 49).

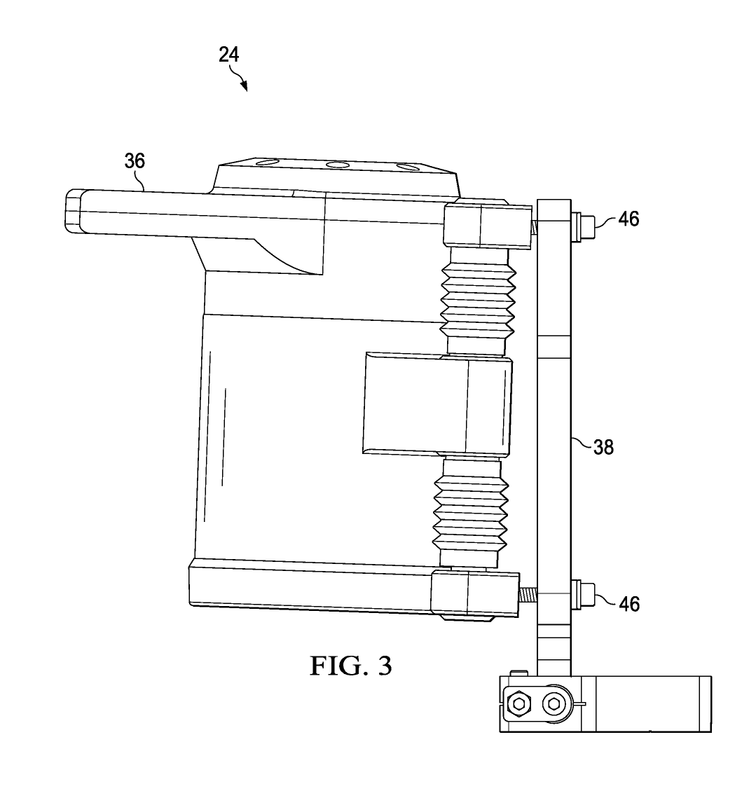

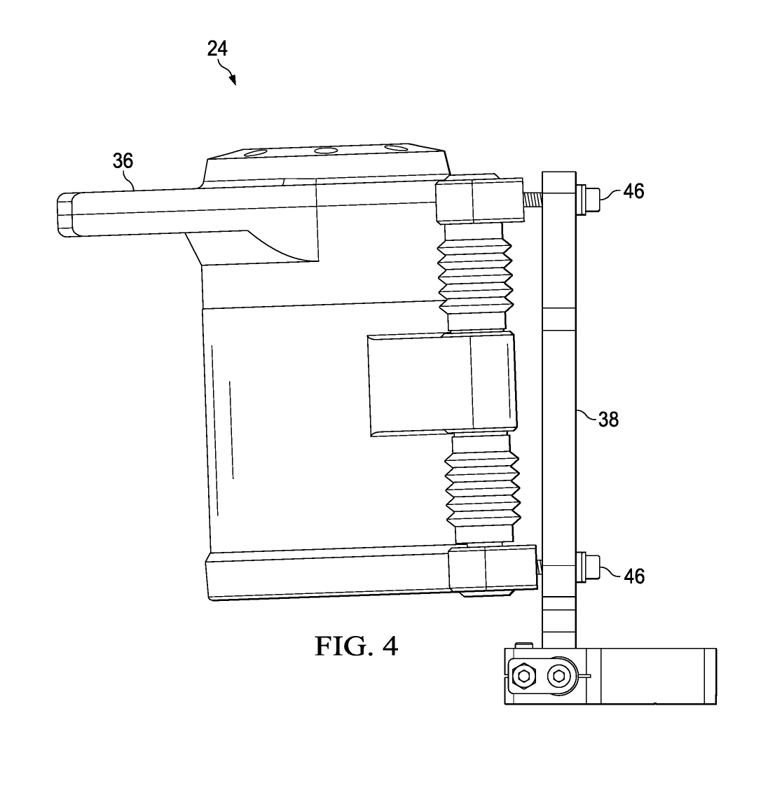

Still referring to FIG. 2, the mount plate 38 can include a plurality of adjustment screws (e.g., 46) and adjustment jacking bolts (e.g., 48). As illustrated in FIGS. 3 and 4, the tip dresser 24 can be releasably attached to the mount plate 38 by the adjustment screws (e.g., 46). The adjustment screws (e.g., 46) and adjustment jacking bolts (e.g., 48) can cooperate to permit fine tuning of the positioning of the tip dresser 24 upon the mount plate 38. For example, as illustrated in FIGS. 3 and 4, the spacing of each side of the tip dresser 24 can be adjusted with the adjustment screws (e.g., 46). Referring again to FIG. 2, the adjustment screws (e.g., 46) can be provided through slotted holes 50 in the mount plate 38 that allow for fine tuning of the rotational position of the tip dresser 24 during installation. It is to be appreciated that when the tip dresser 24 is attached to the head 34, the positioning of the tip dresser 24 can be adjusted to ensure proper interaction with the welding tips of the spot welder (e.g., by adjusting any of the plurality of fasteners 44, the pair of vertical adjustment bolts 45, the adjustment screws (e.g., 46) and the adjustment jacking bolts (e.g., 48)).

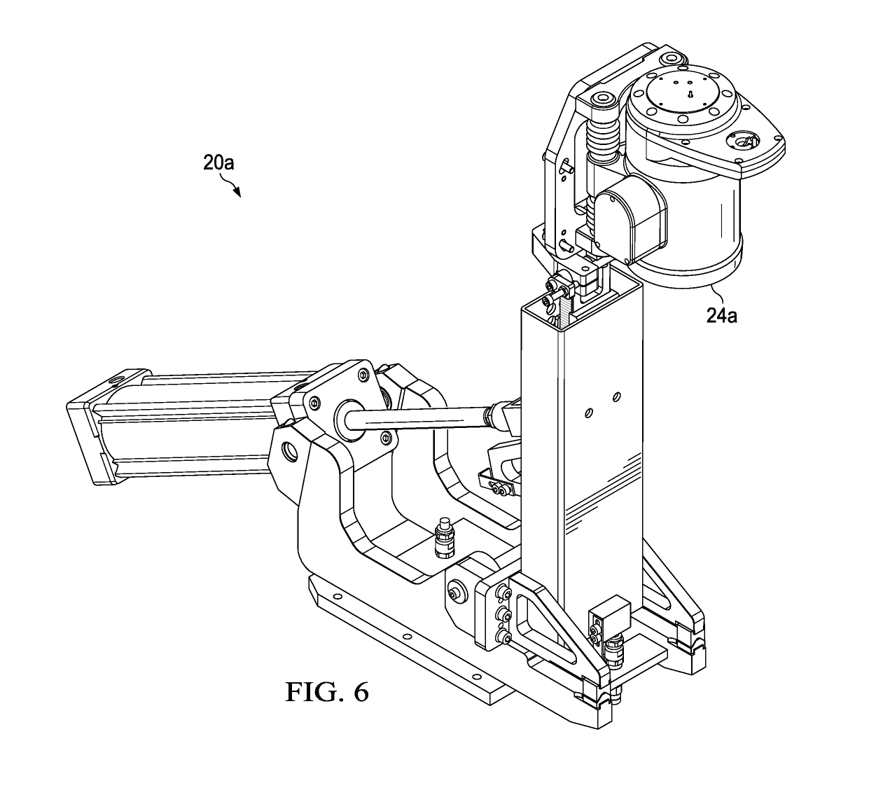

FIGS. 6-9 illustrate various alternative embodiments of swing arm assemblies that are similar to the swing arm assembly 20 illustrated in FIGS. 1-5 except that the swing arm assemblies have different arm lengths and the tip dressers are provided in different orientations.

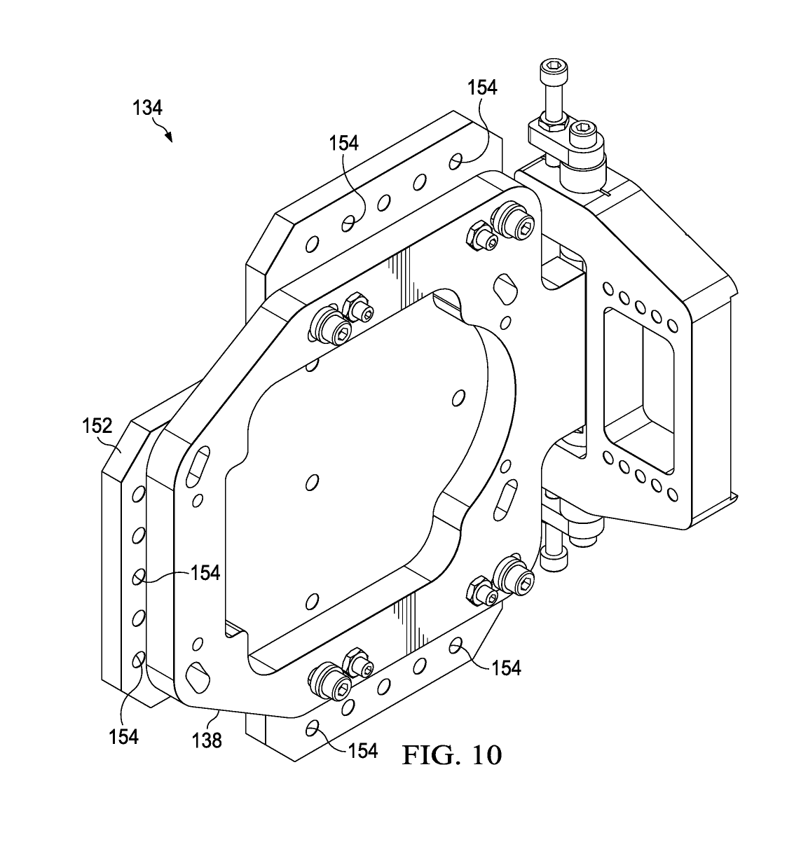

FIG. 10 illustrates an alternative embodiment of a head 134 for a swing arm assembly, the head 134 being similar to, or the same as in many respects as, the head 34 illustrated in FIGS. 1-5. However, the head 134 can include an adapter plate 152 releasably secured to a mount plate 138. The adapter plate 152 can include a plurality of holes 154 that can accommodate a variety of different tip dressers (not shown).

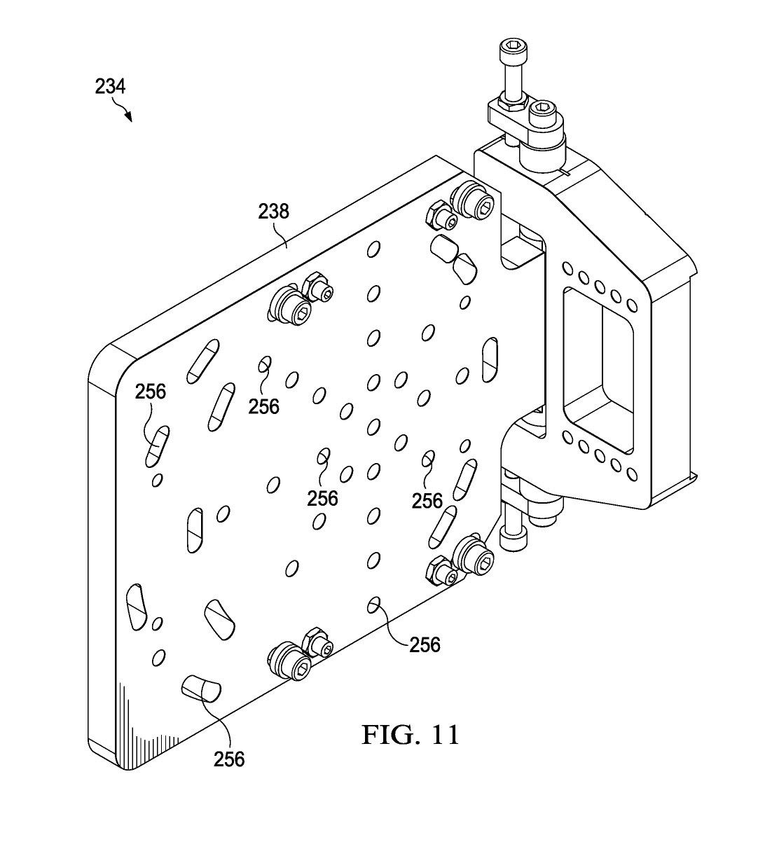

FIG. 11 illustrates another alternative embodiment of a head 234 for a swing arm assembly, the head 234 being similar to, or the same as in many respects as, the head 34 illustrated in FIGS. 1-5. However, a mount plate 238 of the head 234 can include a plurality of different holes 256 that are distributed along the mount plate to accommodate a variety of different tip dressers (not shown).

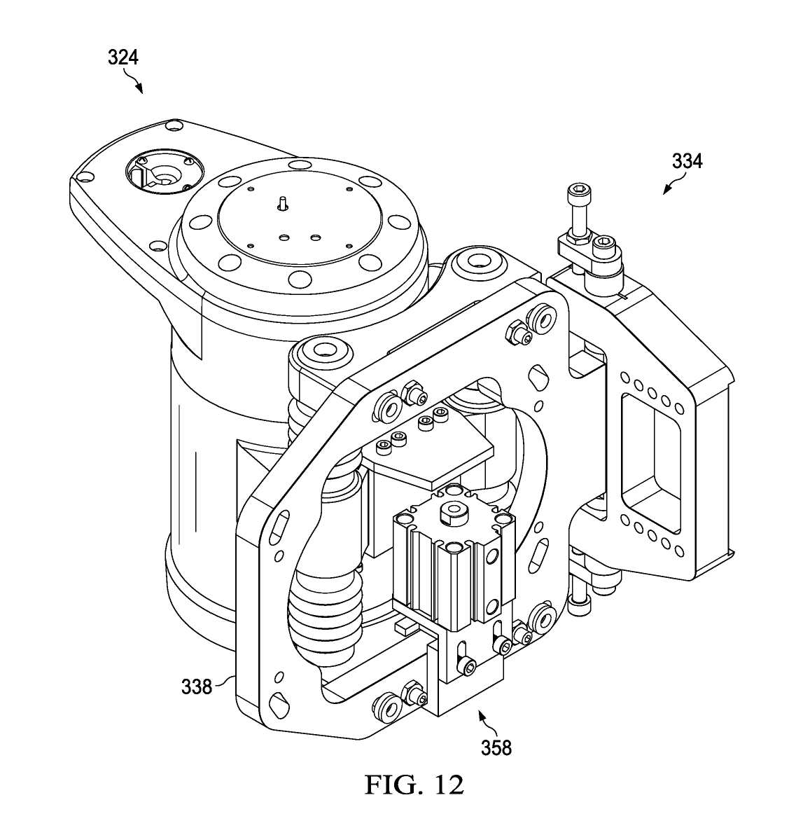

FIG. 12 illustrates another alternative embodiment of a head 334 for a swing arm assembly, the head 334 being similar to, or the same as in many respects as, the head 34 illustrated in FIGS. 1-5. For example, a tip dresser 324 can be mounted to a mount plate 338 of the head 334. However, a lift kit 358 can be releasably secured to the mount plate 338 and can be operably coupled with the tip dresser 324. The lift kit 358 can be configured to facilitate powered vertical movement of the tip dresser 324 for effective positioning of the tip dresser 324 with respect to welding tips.

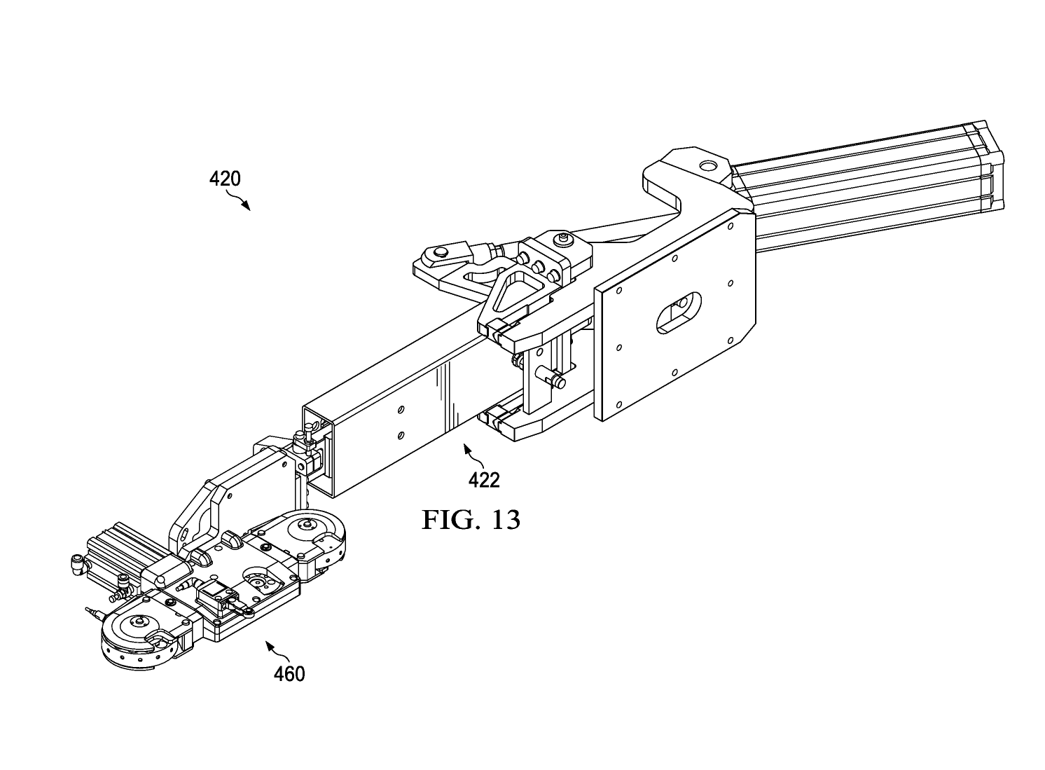

FIGS. 13-15 illustrate yet another alternative embodiment of a swing arm assembly 420 that is similar to, or the same as in many respects as, the swing arm assembly 20 illustrated in FIGS. 1-5. For example, the swing arm assembly 420 can include a swing arm 422. However, the swing arm assembly 420 can include a tip exchanger 460 that is configured to facilitate replacement of tips of a spot welding machine.

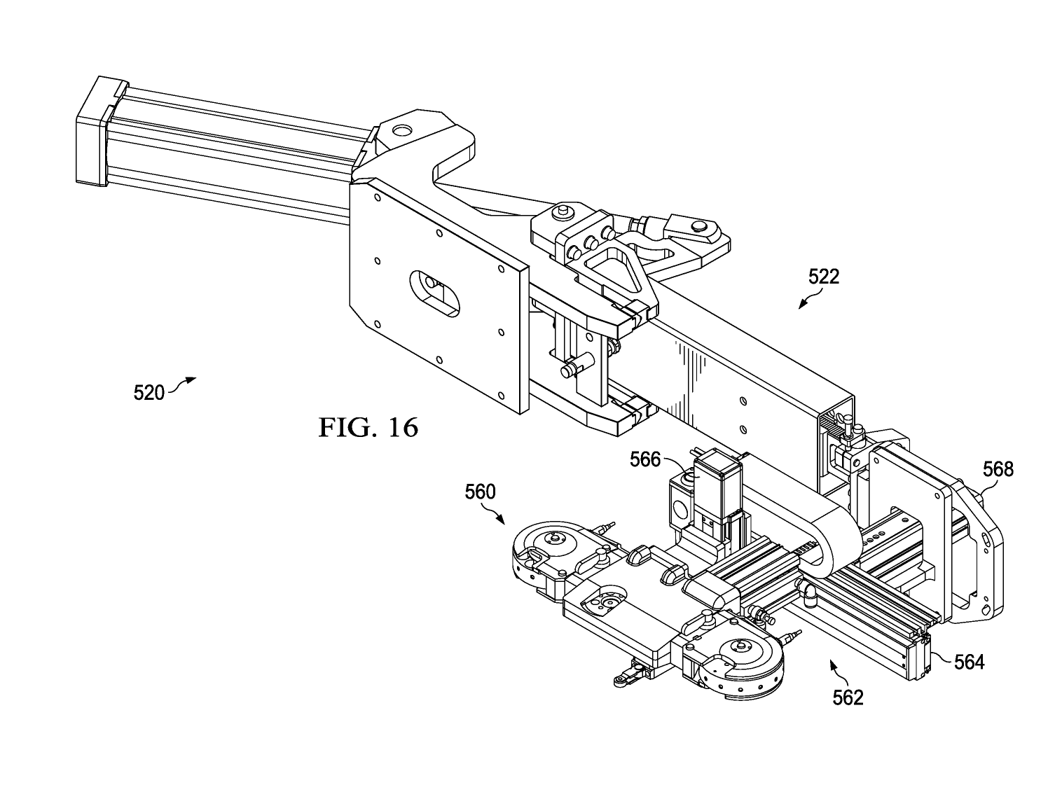

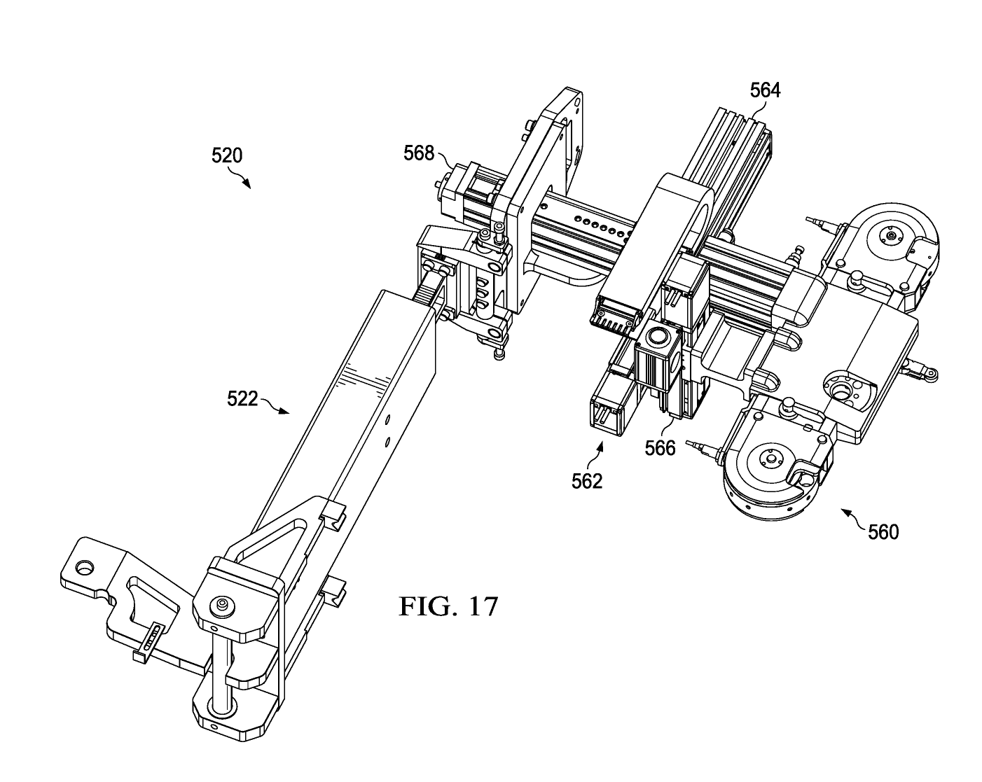

FIGS. 16-19 illustrate yet another alternative embodiment of a swing arm assembly 520 that is similar to, or the same as in many respects as, the swing arm assembly 20 illustrated in FIGS. 1-5. For example, as illustrated in FIGS. 16 and 17, the swing arm assembly 520 can include a swing arm 522. However, the swing arm assembly 520 can include a tip exchanger 560 that is configured to facilitate replacement of tips of a spot welding machine. The swing arm assembly 520 can also include an XYZ servo positioning system 562 that includes an X-axis servo slide 564, a Y-axis servo slide 566, and a Z-axis servo slide 568 that cooperate to facilitate three-dimensional positioning of the tip exchanger 560 with respect to a spot welding machine (not shown).

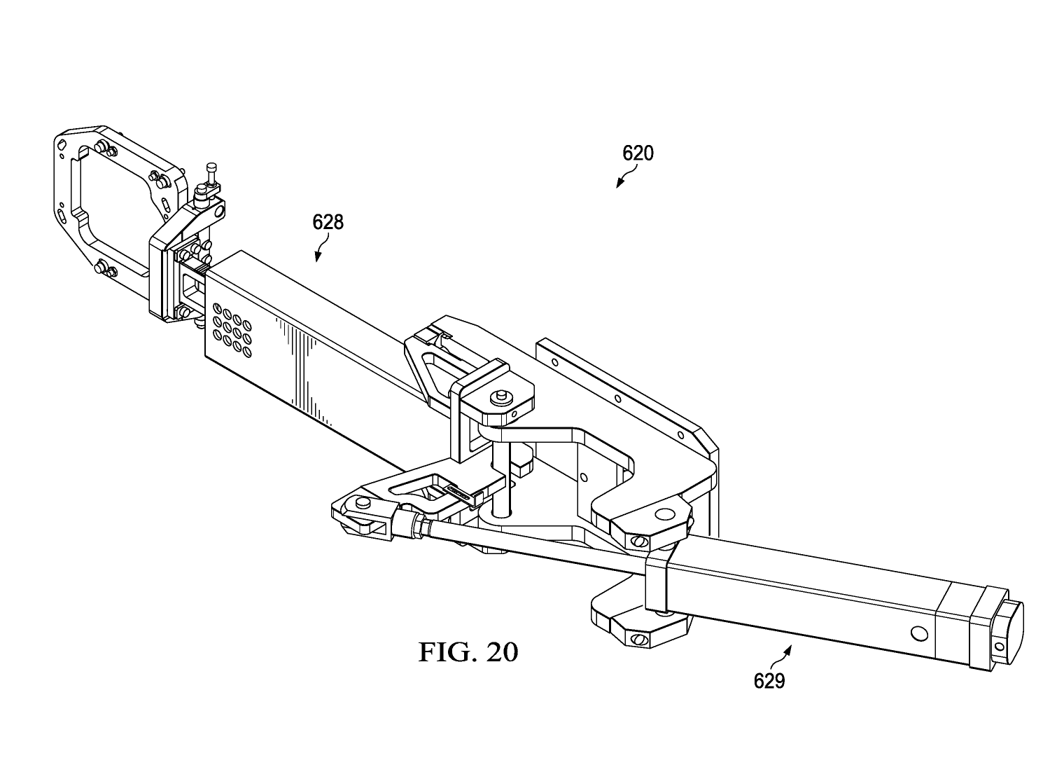

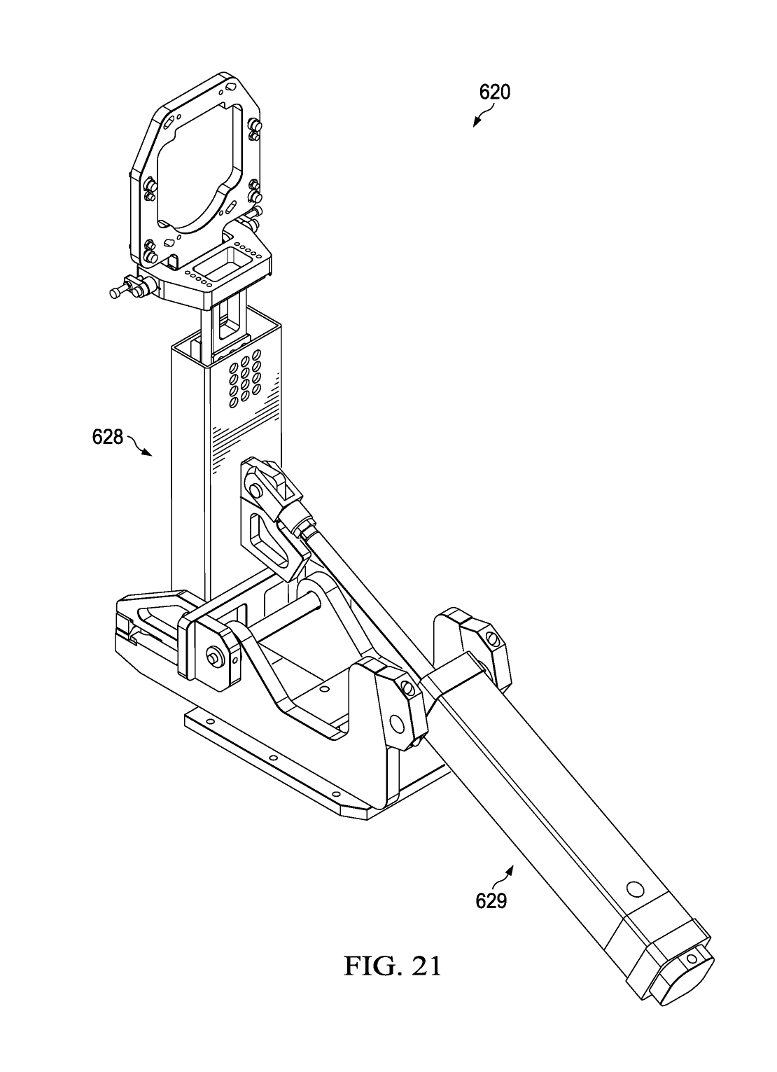

FIGS. 20-21 illustrate yet another alternative embodiment of a swing arm assembly 620 that is similar to, or the same as in many respects as, the swing arm assembly 20 illustrated in FIGS. 1-5. However, the swing arm assembly 620 can include a linear servo actuator 629 that is operable to facilitate pivoting of an arm assembly 628 with respect to a mounting base 626.

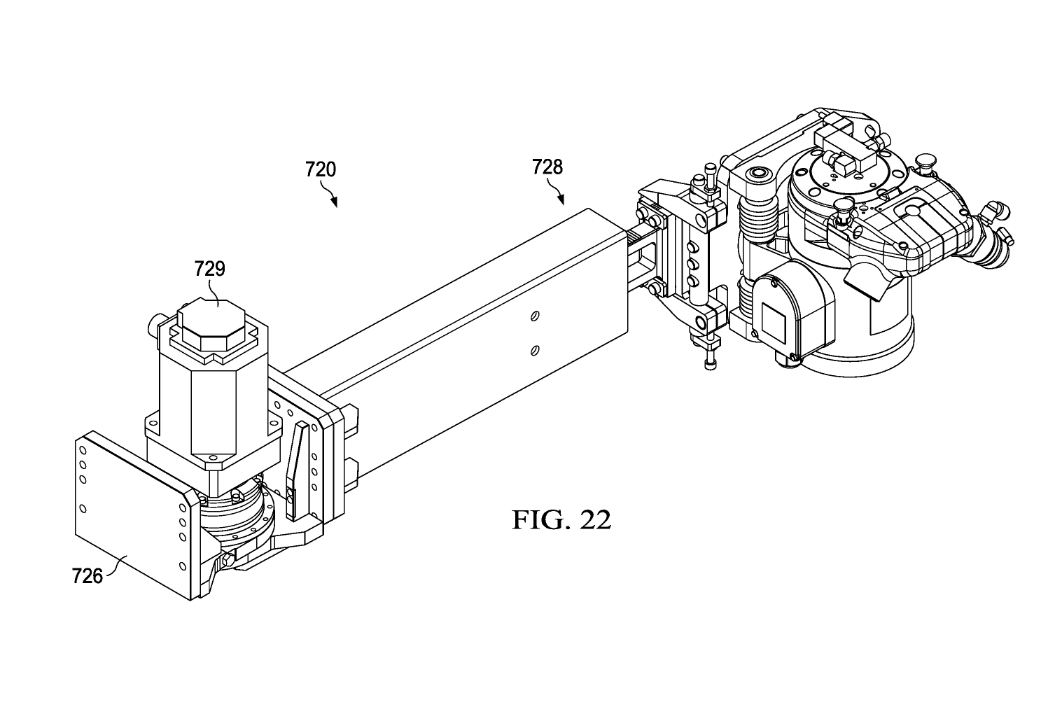

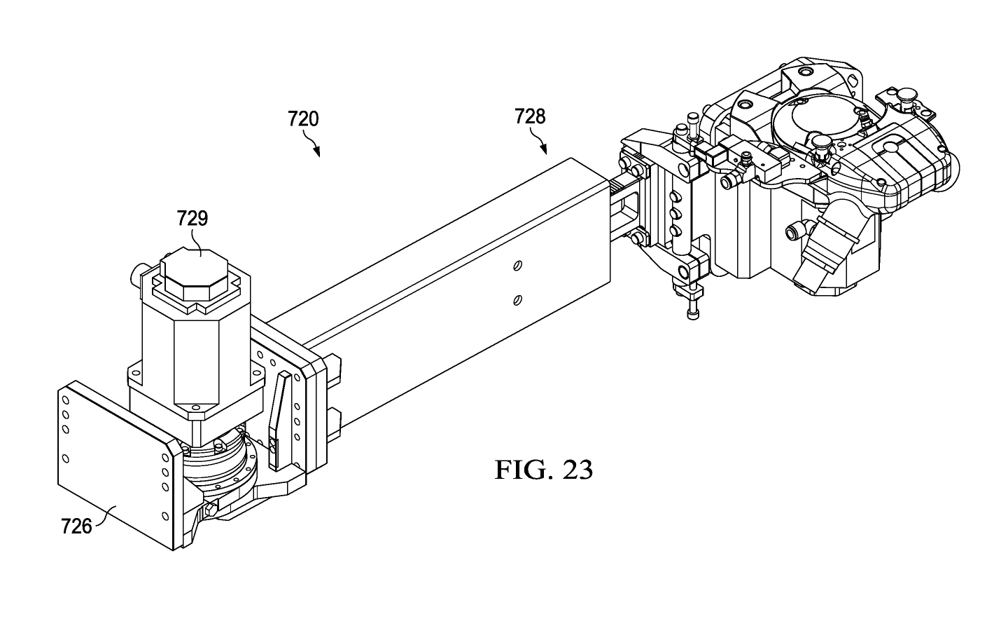

FIGS. 22-23 illustrate yet another alternative embodiment of a swing arm assembly 720 that is similar to, or the same as in many respects as, the swing arm assembly 20 illustrated in FIGS. 1-5. However, the swing arm assembly 620 can include a rotary servo 729 that is operable to facilitate pivoting of an arm assembly 728 with respect to a mounting base 726. The rotary servo 729, in some embodiments, can be an electric motor (e.g., an AC or DC motor). It is to be appreciated that the tip dresser in FIG. 22 is shown to be an rotary electric dresser and the tip dresser in FIG. 23 is shown to be a rotary servo dresser.

The foregoing description of embodiments and examples has been presented for purposes of illustration and description. It is not intended to be exhaustive or limiting to the forms described. Numerous modifications are possible in light of the above teachings. Some of those modifications have been discussed and others will be understood by those skilled in the art. The embodiments were chosen and described for illustration of various embodiments. The scope is, of course, not limited to the examples or embodiments set forth herein, but can be employed in any number of applications and equivalent devices by those of ordinary skill in the art. Rather, it is hereby intended that the scope be defined by the claims appended hereto.

What is claimed is:

1. A swing arm for one or more of a tip dresser and a tip exchanger for a spot welding machine, the swing arm comprising:
a base;
an arm pivotally coupled with the base; and
a head coupled with the arm and configured to accommodate one or more of a tip dresser and a tip exchanger for a spot welding machine, the head comprising:
a support member attached to the arm; and
a mount plate rotatably and slidably coupled with the support member such that the mount plate is rotatable and slidable about a first axis.

2. The swing arm of claim 1 wherein the head is slidably coupled with the arm such that the head is extendible along a second axis that is substantially perpendicular to the first axis.

3. The swing arm of claim 1 wherein the mount plate comprises a rotational adjustment tube that facilitates rotatable and slidable coupling of the mount plate to the support member and wherein the rotational adjustment tube comprises a plurality of fasteners that facilitate selective rotational positioning of the mount plate with respect to the support member.

4. The swing arm of claim 1 further comprising a plurality of vertical adjustment bolts associated with the support member and that facilitate selective positioning of the mount plate along the first axis with respect to the support member.

5. The swing arm of claim 4 further comprising a pair of extension plates coupled with the mount plate such that the mount plate is disposed between the extension plates and wherein each vertical adjustment bolt is threaded through one of the extension plates and into contact with the support member.

6. The swing arm of claim 1 wherein the mount plate further comprises:
a plurality of adjustment screws that facilitate releasable attachment of one or more of a tip dresser and a tip exchanger to the mount plate; and
a plurality of adjustment jacking bolts that facilitate adjustment of the spacing of one or more of a tip dresser and a tip exchanger with respect to the mount plate.

7. The swing arm of claim 1 wherein the support member comprises a plurality of through holes that facilitate selective lateral positioning of the support member relative to the arm.

8. The swing arm of claim 1 further comprising a driver cylinder operably mounted to the arm that facilitates in powered pivoting of the arm with respect to the base.

9. A welding system comprising:
a spot welding machine;
a swing arm comprising:
a base;
an arm pivotally coupled with the base; and
a head coupled with the arm and comprising:
a support member attached to the arm; and
a mount plate rotatably and slidably coupled with the support member
such that the mount plate is rotatable and slidable about a first axis; and
one or more of a tip dresser and a tip exchanger coupled with the mount plate.

10. The welding system of claim 9 wherein the head is slidably coupled with the arm such that the head is extendible along a second axis that is substantially perpendicular to the first axis.

11. The welding system of claim 9 wherein the mount plate comprises a rotational adjustment tube that facilitates rotatable and slidable coupling of the mount plate to the support member and wherein the rotational adjustment tube comprises a plurality of fasteners that facilitate selective rotational positioning of the mount plate with respect to the support member.

12. The welding system of claim 9 further comprising a plurality of vertical adjustment bolts associated with the support member and that facilitate selective positioning of the mount plate along the first axis with respect to the support member.

13. The welding system of claim 12 further comprising a pair of extension plates coupled with the mount plate such that the mount plate is disposed between the extension plates and wherein each vertical adjustment bolt is threaded through one of the extension plates and into contact with the support member.

14. The welding system of claim 9 wherein the mount plate further comprises:
a plurality of adjustment screws that releasably attach the one or more of the tip dresser and the tip exchanger to the mount plate; and
a plurality of adjustment jacking bolts that facilitate adjustment of the spacing of the one or more of the tip dresser and the tip exchanger relative to the mount plate.

15. The welding system of claim 9 wherein the support member comprises a plurality of through holes that facilitate selective lateral positioning of the support member relative to the arm.

16. The welding system of claim 9 further comprising a driver cylinder operably mounted to the arm that facilitates in powered pivoting of the arm with respect to the base.

17. A head for a swing arm for one or more of a tip dresser and a tip exchanger for a spot welding machine, the head configured to accommodate one or more of a tip dresser and a tip exchanger for a spot welding machine and comprising:
a support member attached to the arm; and
a mount plate rotatably and slidably coupled with the support member such that the mount plate is rotatable and slidable about a first axis.

18. The head of claim 17 wherein the mount plate comprises a rotational adjustment tube that facilitates rotatable and slidable coupling of the mount plate to the support member and wherein the rotational adjustment tube comprises a plurality of fasteners that facilitate selective rotational positioning of the mount plate with respect to the support member.

19. The head of claim 17 further comprising a plurality of vertical adjustment bolts associated with the support member and that facilitate selective positioning of the mount plate along the first axis with respect to the support member.

20. The head of claim 17 further comprising:
a plurality of adjustment screws that facilitate releasable attachment of one or more of a tip dresser and a tip exchanger to the mount plate; and
a plurality of adjustment jacking bolts that facilitate adjustment of the spacing of one or more of a tip dresser and a tip exchanger with respect to the mount plate.
